(19) United States
(12) Patent Application Publication
(10) Pub. No.: US 2024/0380585 A1
(43) Pub. Date: Nov. 14, 2024

(54) METHOD AND SYSTEM FOR GENERATING A SECRET KEY USING NON-COMMUNICATING ENTITIES

(71) Applicant: Visa International Service Association, San Francisco, CA (US)

(72) Inventors: Sunpreet Arora, Union City, CA (US); Saikrishna Badrinarayanan, Fremont, CA (US); Srinivasan Raghuraman, Cambridge, MA (US); Maliheh Shirvanian, Cupertino, CA (US); Kim Wagner, Sunnyvale, CA (US); Gaven Watson, Palo Alto, CA (US)

(73) Assignee: Visa International Service Association, San Francisco, CA (US)

(21) Appl. No.: 18/682,080

(22) PCT Filed: Aug. 20, 2021
(86) PCT No.: PCT/US2021/046851

§ 371 Date: Feb. 7, 2024

(51) Int. Cl. H04L 9/08; H04L 9/32

(52) U.S. Cl. CPC H04L 9/0894; H04L 9/085; H04L 9/0863; H04L 9/3231

(57) ABSTRACT

A method for performing a key recovery process is disclosed. The method comprises entering, in a user device, a user identifier unique to a user. The user device may then obscure the user identifier to form an obscured user identifier. The user device may then transmit the obscured user identifier to a first and second entity computer. The method may then include the first entity computer generating a first output using the obscured user identifier and a first share, and the second entity computer generates a second output using the obscured user identifier and a second share. As a response to transmitting the obscured identifier, the user device may receive the first output from the first entity computer and the second output from the second entity computer. The user device may then generate a secret key after processing the first output and the second output, completing the key recovery process.

### CROSS-REFERENCES TO RELATED APPLICATIONS

None.

### BACKGROUND

A secret (e.g., a password such as an alphanumeric string, a cryptographic key, etc.) is commonly used by a user operating a user device to securely access a resource, such as an account, or a location. For example, the user may use the user device to encrypt data with a cryptographic key and transmit the encrypted data to an external device. The user device may then store the secret, so that it may be used to later access the encrypted data from the external device. In some cases, the secret may only be stored on the user device. Therefore, if the user loses access to the user device, the cryptographic key may also be lost.

Some existing methods to recover secrets use multiple user devices in order to recover the secret. This requires the user to have a backup user device, resulting in a higher cost to the user, and the risk of loss exists for the backup user device. The backup device may then be used to access the resource, but some methods do not recover the secret.

Other existing methods allow the external device to store the secret. These methods place a burden on the external device, requiring the external device to have the ability to securely store the secret. Additionally, these methods place complete trust in the external device. If the external device is misused, the user's secret may be compromised, or if the external device malfunctions, the user may not be able to recovery the secret.

Embodiments of the disclosure address these problems and other problems individually and collectively.

### SUMMARY

One embodiment of the invention includes a method. The method comprising: receiving, in a user device, a user identifier unique to a user; obscuring, by the user device, the user identifier, with a function to form an obscured user identifier; transmitting, by the user device, the obscured user identifier to a first entity computer; transmitting, by the user device, the obscured user identifier to a second entity computer; wherein the first entity computer and the second entity computer do not communicate with each other in the method, and wherein the first entity computer generates a first output after receiving the obscured user identifier, and the second entity computer generates a second output after receiving the obscured user identifier; receiving, by the user device, the first output from the first entity computer; receiving, by the user device, the second output from the second entity computer; and generating a secret key after processing the first output and the second output.

Another embodiment is related to a user device comprising: a processor; and a non-transitory a computer readable medium, the computer readable medium comprising code, executable by the processor, to perform a method including receiving a user identifier unique to a user; obscuring the user identifier, with a function to form an obscured user identifier; transmitting the obscured user identifier to a first entity computer; transmitting the obscured user identifier to a second entity computer; wherein the first entity computer and the second entity computer do not communicate with each other in the method, and wherein the first entity computer generates a first output after receiving the obscured user identifier, and the second entity computer generates a second output after receiving the obscured user identifier; receiving the first output from the first entity computer; receiving the second output from the second entity computer; and generating a secret key after processing the first output and the second output.

Yet another embodiment is related to a method comprising: receiving, by a first entity computer, an obscured user identifier from a user device, the obscured user identifier formed using a function and a user identifier unique to the user, and wherein the user device also transmits the obscured user identifier to a second entity computer, and wherein the first entity computer and the second entity computer do not communicate with each other in the method; generating, by the first entity computer, a first output after receiving the obscured user identifier, and wherein the second entity computer generates a second output after receiving the obscured user identifier; and transmitting, by the first entity computer, the first output to the user device, wherein the user device generates a secret key after processing the first output and the second output received from the second entity computer

Further details regarding embodiments of the invention better understanding of the nature and advantages of embodiments of the invention may be gained with reference to the following detailed description and accompanying drawings.

### BRIEF DESCRIPTION OF THE DRAWINGS

FIG. 1 shows a block diagram of a system that shows a user device in direct communication with two non-communicating entity computers including a first entity computer and a second entity computer.

FIG. 2 shows a flow diagram for storing a secret and recovery parameters with non-communicating entity computers.

FIG. 3 shows a flow diagram for a user device recovering a secret key using a password guess.

FIGS. 4A and 4B show a flow diagram for a user device recovering a secret key using a biometric measurement.

FIG. 5 shows a block diagram of functions of a threshold oblivious pseudorandom function.

FIG. 6 shows a block diagram of an exemplary user device.

FIG. 7 shows a block diagram of an exemplary entity computer.

### DETAILED DESCRIPTION

Prior to discussing embodiments of the disclosure, some terms can be described in further detail.

A “user” may include an individual or a machine. In some embodiments, a user may be associated with one or more user devices.

A “user device” may be any suitable device that is operated by a user. User devices may be in any suitable form. Some examples of user devices include cellular phones, a card (e.g., a payment card), PDAs, personal computers (PCs), tablet computers, and the like. In some embodiments, where a user device is a mobile device, the mobile device may include a display, a memory, a processor, a computer-readable medium, and any other suitable component.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g. 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g. cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device).

A “user identifier” may include any suitable information or combination of information to identify a user. Examples of user identifiers may include biometric samples and biometric templates, such as those derived from facial scans, fingerprints, retinal scans and the like. User identifiers may also include passwords or secrets known the user.

A “trusted entity” may be an entity that is trusted by a user. The trusted entity may securely provide data or services to the user. Examples of a trusted entity may be a governmental institution, a financial institution such as a bank or payment processing network, an educational institution such as a university or college, etc. In some embodiments, a trusted entity may operate an entity computer.

A “key” or a “cryptographic key” may include a piece of information that is used in a cryptographic algorithm to transform data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

In embodiments of the invention, a user operating an original user device may cause the original user device to generate a cryptographic key to encrypt sensitive data. In particular, the user may cause the original user device to generate a public-private key pair, and the private key may be the cryptographic key. The user device may then store the generated cryptographic key in a secure memory.

At a later time, the user may cause original user device to encrypt sensitive data (e.g., sensitive data such as financial data, identity data, etc.) using the cryptographic key. The user may then transmit the encrypted sensitive data to an external computer, where it can be securely stored. At a later time, the user may cause the user device to request the encrypted data from the external computer, so that the user can decrypt the data using the cryptographic key.

It is possible, however, that the user may lose their original user device. This can result in the user losing the cryptographic key, since the cryptographic key never leaves the original user device. As a result, the user may not be able to decrypt any requested encrypted data.

In some cases, the user may try and access the encrypted data using a second user device, after the user loses the original user device. However, as the cryptographic key was stored securely on the original user device, the second user device would not be able to decrypt any encrypted data that was formed using the cryptographic key stored on the original user device.

Embodiments of the invention allow the user to recover a cryptographic key using a user device that is not the original user device.

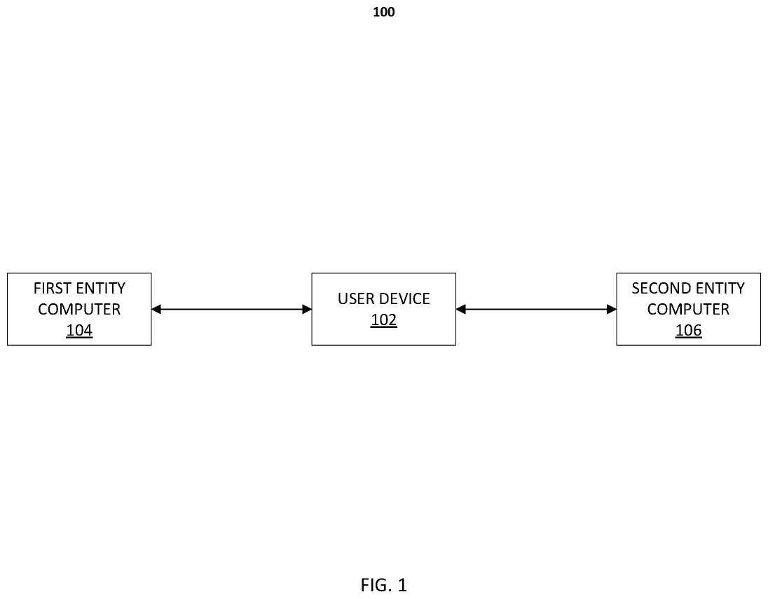

FIG. 1 shows a block diagram of a system 100 of a user device 102 in direct communication with non-communicating entity computers including a first entity computer 104 and a second entity computer 106. The first entity computer 104 may be in direct communication with the user device 102 and the second entity computer 106 may be in direct communication with the user device 102. However, the first entity computer 104 and the second entity computer 106 may be a non-communicating computer pair.

The user device 102, and the first entity computer 104 or the second entity computer 106, may be in operative communication with each other through any suitable communication channel(s) or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The first entity computer 104 and second entity computer 106 may be operated by separate trusted entities such as government institutions, financial institutions, data warehouses, etc. For example, the first entity computer 104 may be a payment processing network computer, and the second entity computer 104 could be a financial institution such as a bank that holds an account of the user of the user device 102. The user device 102 may communicate with either or both of the first and second entity computers 104, 106 to store encrypted data. For example, the user device 102 may wish to store encrypted identity data (e.g., data such as name, date of birth, government issued identification number, home address, phone number, account numbers, etc.) or encrypted assertions of identity data (e.g., user A is over 21 years hold, user A has more than one credit card account, etc.) with the first entity computer 104.

In conventional methods, the user device 102 would encrypt data with a secret key (e.g., a private key) and would transmit the encrypted data to the first entity computer 104. At a later time, the user device 102 would then use the secret key to decrypt the encrypted data when it is retrieved from the first entity computer 104.

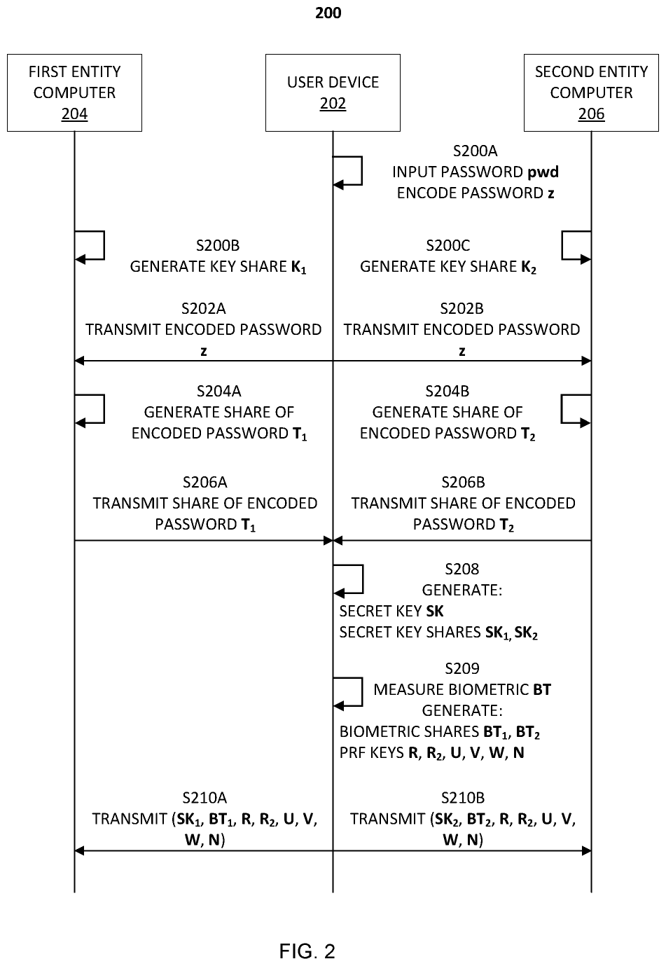

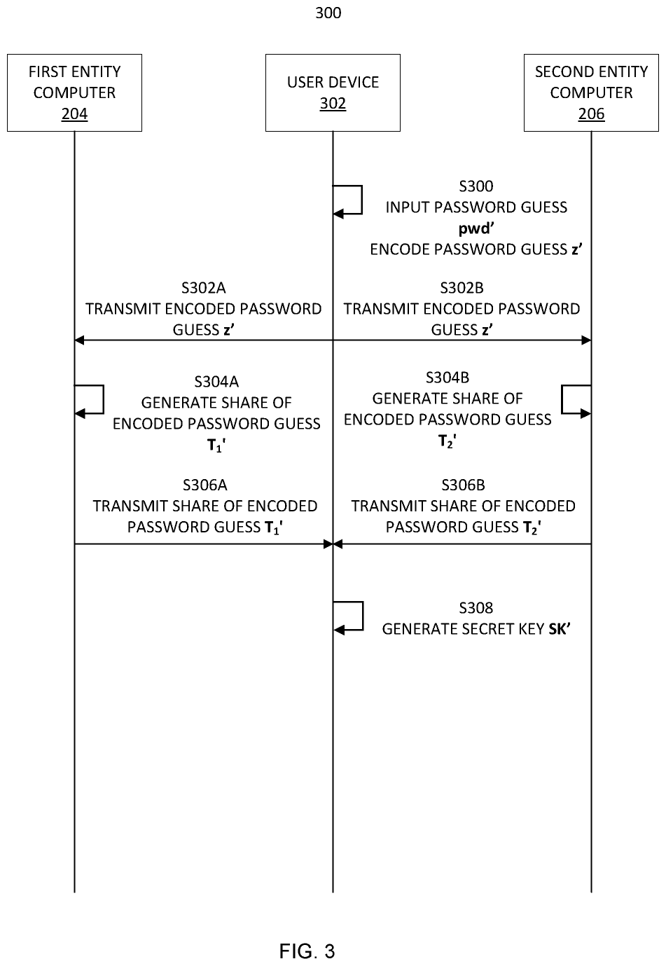

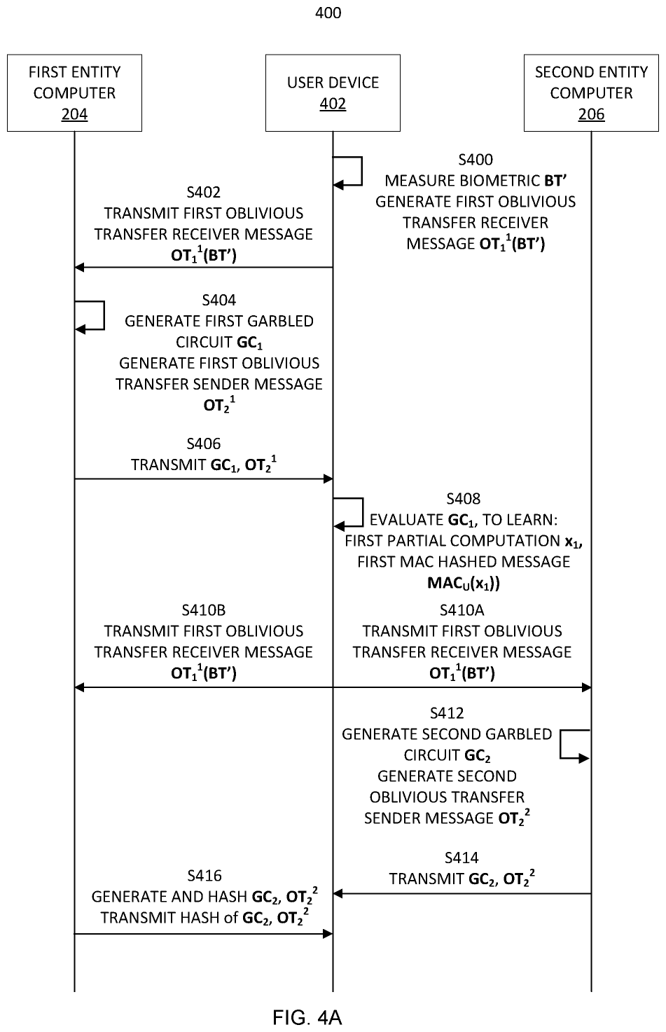

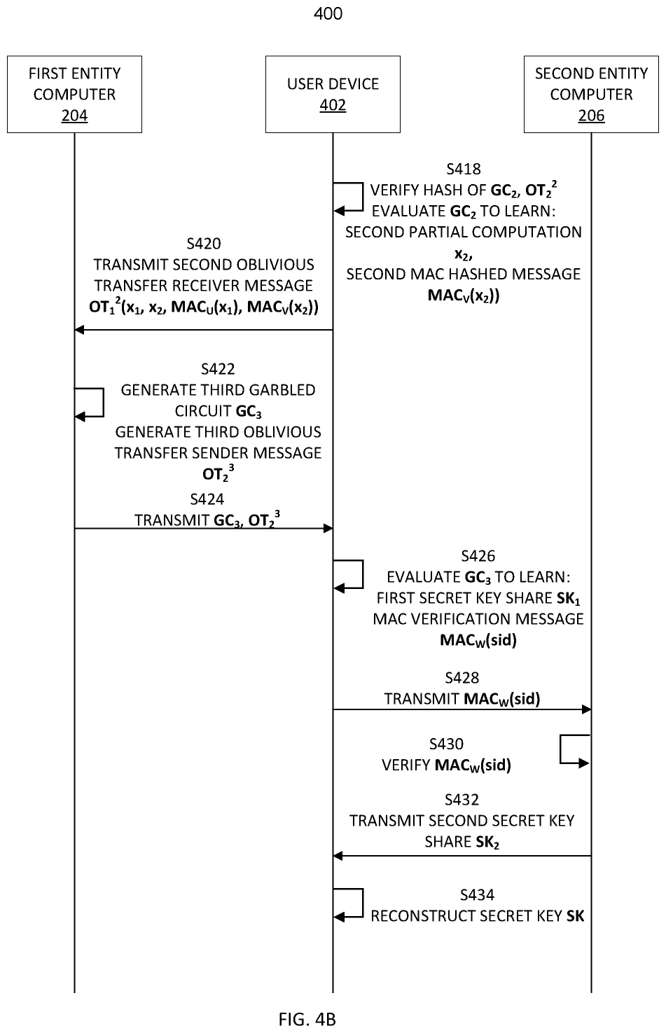

FIG. 2 shows a flow diagram for generating a secret key (SK) by a user device, and the distributing a first set of recovery parameters (e.g., SK₁, BT₁, R, R₂, U, V, W, N) to a first entity computer 204 and a second set of recovery parameters (e.g., SK₂, BT₂, R, R₂, U, V, W, N) to a second entity computer 206, wherein at least some of the parameters (e.g., SK₁ and SK₂) in the first and second set of recovery parameters are different. The various recovery parameters are described in further detail below in the methods disclosed in FIGS. 3 and 4. FIG. 3 shows a method for recovering a secret key using a password guess. FIG. 4 shows a method for recovering a secret key using a biometric measurement.

A user may wish to generate a secret key that will be used to encrypt data. The encrypted data may be stored with at an external computer, such as the first entity computer 204 or the second entity computer 206. The user operating a user device 202 may choose to set up a recovery for the secret key using personal user data such as one or more of password and/or a biometric template. The method shown in FIG. 2 may be performed before the user device 102 transmits encrypted data to the first entity computer 104 and/or the second entity computer 106.

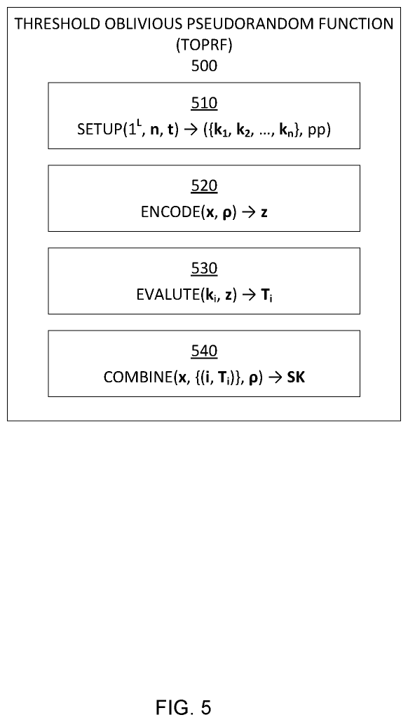

In step S200A, the user operating the user device 202 may input a password, pwd, into the user device 202. The user device 202 may then encode the password, pwd, to form an encoded password, z. The user device 202 may encode the password using, for example, a threshold oblivious pseudorandom function (TOPRF). One construction of a TOPRF is described in Agrawal, et. Al PASTA: PASsword-based Threshold Authentication, Cryptology ePrint Archive, Report 2018/885, 2018. The threshold oblivious pseudorandom function may have an encoding function which takes as input a string and a random number ρ, then output an encoding of the string according to the random number ρ. For example, the encoding function may hash the password, pwd, using a public hashing function H and raise the hashed password to the random number ρ to form the encoded password z=H(pwd)^{ρ}. Further details of the threshold oblivious pseudorandom function are described in reference to FIG. 5.

Prior to step S200B, the user device 202 may communicate with the first entity computer 204 and the second entity computer 206 regarding the user's desire to set up a key recovery process.

In step S200B, after receiving the communication from the user device 202 that it wants to set up a secret key recovery process, the first entity computer 204 may generate and store a first pseudorandom function key share, K₁. The first entity computer 204 may use a setup function of a threshold oblivious pseudorandom function to generate the pseudorandom function key share, K₁.

In some embodiments, the first entity computer 204 may begin with a set of initial inputs including a value k, which can be a security parameter which determines the size of the key share to be formed. The set of inputs may also include a value such as n, which may be the number of shares to be generated, and t, which is a threshold, which determines the number of shares needed to construct a secret key. In this example, n and t may be equal to “1” because the first entity computer 204 only generates a key share K₁ for itself. The initial input k may be input into a function GroupGen (1^{k}) to obtain parameters including p, g, and G. p can be used to define Zₚ, which may be a set of integers dependent upon p. A value sk₁ may be randomly selected from the set of numbers Zₚ. The values p, n, t, and sk₁ may then be input into a GenShare function to obtain the key share K₁. Further details on the GroupGen and GenShare functions can be found in Agrawal, et al. “PASTA: PASsword-based Threshold Authentication,” Cryptology ePrint Archive, Report 2018/885, 2018.

The pseudorandom function key share, K₁, may be used by a pseudorandom function (e.g., a function such as the threshold oblivious pseudorandom function) to mask an input value (e.g., such as the encoded password z) so that is appears to be random, even though it is not. The second entity computer 206 may perform a similar step in S200C to generate and store a second pseudorandom function key share, K₂. The first and second pseudorandom function key shares, K₁ and K₂ may be different, since the second entity computer 206 would have selected different random value sk₂ from the set of numbers Zₚ. The values sk₁ and sk₂ could be stored by the first entity computer 204 and the second entity computer 206, respectively, so that these values could be used in a secret key regeneration process (described in FIG. 3).

Note that although a specific process is described for generating the first and second pseudorandom function key shares, K₁ and K₂, they can be generated in other ways. For instance, they may be random numbers selected from a pre-defined numerical space, where the random numbers have the same length in binary space, or they may be generated by the user device 202 and transmitted to the entity computers.

In step S202A, after encoding the password, pwd, to form the encoded password, z, the user device 202 may transmit the encoded password, z, to the first entity computer 204. Similarly, in step S202B, the user device 202 may transmit the encoded password, z, to the second entity computer 204.

In step S204A, after receiving the encoded password, z, the first entity computer 204 may generate a first share of the encoded password, T₁. The first share of the encoded password, T₁, may be an output of an evaluation function of the threshold oblivious pseudorandom function. The evaluation function may take the first pseudorandom function key share, K₁, and the encoded password, z, as input to generate the first share of the encoded password, T₁. For example, the evaluation function may raise the encoded password, z, to the power of the first pseudorandom function key share, K₁, to generate the first share of the encoded password, T₁=z^{K1}. In step S204B, the second entity computer 206 may perform a similar process to generate a second share of the encoded password, T₂.

In step S206A, after generating a first share of the encoded password, T₁, the first entity computer 204 may transmit the first share of the encoded password, T₁, to the user device 202. In step S206B, the second entity computer 206 may transmit the second share of the encoded password, T₂, which may be T₂=z^{K2}.

In step S208, after receiving both the first and second shares of the encoded passwords T₁ and T₂, the user device 202 may generate a secret key, SK. The user device 202 may use a combine function of the threshold oblivious pseudorandom function to generate the secret key SK. The combine function may use the password, pwd, two shares of the encoded password, T₁ and T₂, and the random value, ρ, used to encode the password as input to generate the secret key, SK.

For example, the user device 202 may multiply the two shares T₁ (i.e., z^{K1}) and T₂ (i.e., z^{K2}) to obtain a value v. The secret key SK may be obtained using an equation such as SK=hash(pwd∥^{ρ}\sqrt{v}).

The user device 202 may then use the secret key, SK, to generate a first secret key share, SK₁, and a second secret key share, SK₂. The user device 202 may use any suitable key share forming technique to form the first and second secret key shares, SK₁ and SK₂. Suitable key share forming techniques may include Shamir's secret sharing, or simply splitting the secret key, SK, into two shares (and potentially pad the resulting two shares). The secret key, SK, may be used to encrypt data, such as the identity data described in FIG. 1.

In step S209, the user device 202 may use a biometric sensor in the user device 202 to measure a biometric template, BT, of the user operating the user device 202. For example, the user device 202 may use a camera to take a picture of the user's face, and the user device 202 may form a biometric template from it. In another example, the user device 202 may use a fingerprint scanner to scan a fingerprint of the user, and may form a biometric template from it. The user device 202 may then use the biometric template, BT, to generate a first biometric share, BT₁, and a second biometric share, BT₂. The biometric shares may be generated in a similar manner to the shares of the secret key.

The user device 202 may then generate and store several pseudorandom function keys. The user device 202 may generate a garbled circuit randomness, R, a second random value, R₂, three message authentication code (MAC) key generators (U, V, W), and a session identifier generator, N. The garbled circuit randomness, R, and the second random value, R₂, may be used by the first and second entity computers to generate garbled circuits. The pseudorandom function keys may be used by the first and second entity computers 204, 206 during a later recovery attempt. The three MAC key generators (U, V, W) may be used to generate three unique MAC keys. The three MAC keys may be keys used to authenticate three different messages. For example, one MAC key may be used in a recovery attempt to authenticate that a message came from the first entity computer 204, and that the message was not altered. The session identifier generator, N, may be used to efficiently verify a computation (e.g., a comparison of a biometric measurement to the biometric template in FIG. 4).

In step S210A, the user device 202 may transmit one or more of the first secret key share, SK₁, the first biometric share, BT₁, the garbled circuit randomness, R, the second random value, R₂, the three MAC key generators (U, V, W), and the session identifier generator, N, to the first entity computer 204.

In step S210B, the user device 202 may transmit one or more of the second secret key share, SK₂, the second biometric share, BT₂, the garbled circuit randomness R, the second random value, R₂, the three MAC key generators (U, V, W), and the session identifier generator, N, to the second entity computer 206.

After the first and second entity computers 204, 206 receive the data in steps S210A and S210B, a recovery attempt may be made. For example, the user operating the user device 202 may wish to retrieve data that was encrypted using the secret key, SK. The user device 202 may initiate a recovery attempt and using a user identifier unique to the user (e.g., either one or both of the password, pwd, or the biometric template, BT) to authenticate the user.

Note that all steps in FIG. 2 are not needed in all key recovery processes. For example, FIG. 3 shows a flow diagram for a user device 302 recovering a secret key using a password guess. The measurement of a biometric as in step S209 is not required to set up the system to perform the method of FIG. 3.

As noted above, FIG. 3 shows a flow diagram for a user device 302 recovering a secret key using a password guess. A recovery attempt may be made by the user device 302 to recover the secret stored in FIG. 2. The recovery attempt may include an authentication, and if the authentication is successful, recovery of the secret. The user device 302 may be the same or different user device as the user device 202 in FIG. 2. For example, if the user loses access to the user device 202, they may use the user device 302 to recover the secret key SK.

In step S300, the user operating the user device 302 may input a password guess, pwd′. The password guess, pwd′, may be an example of a user identifier unique to the user. The user device 302 may then obscure the user identifier unique to the user. For example, the user device 302 may encode the password guess, pwd′, to form an encoded password guess, z′. The user device 302 may perform the encoding in a similar manner to the encoding in step S200 of FIG. 2. For example, the same encoding function of the threshold oblivious pseudorandom function may be used with the same random number, ρ, as in step S200.

In step S302A, after encoding the password guess, pwd′, to form, z′, the user device 302 may transmit the encoded password guess, z′, to the first entity computer 204. Similarly, in step S302B, the user device 302 may transmit the encoded password guess, z′, to the second entity computer 206.

In step S304A, after receiving the encoded password guess, z′, the first entity computer 204 may generate a first share of the encoded password guess, T₁′. The first share of the encoded password guess, T₁′, may be an example of a first output. The first share of the encoded password guess, T₁′, may be an output of the evaluation function of the threshold oblivious pseudorandom function used in step S204A of FIG. 2. The evaluation function may take the stored first pseudorandom function key share, K₁, and the encoded password guess, z′, as input to generate the first share of the encoded password guess, T₁′. In step S304B, the second entity computer 206 may perform a similar step to generate a second share of the encoded password guess, T₂′. The second share of the encoded password guess, T₂′, may be an example of a second output.

In step S306A, after generating a first share of the encoded password guess, T₁′, the first entity computer 204 may transmit the first share of the encoded password guess, T₁′, to the user device 302. In step S306B, the second entity computer 206 may transmit the second share of the encoded password guess, T₂′, to the user device 302.

In step S308, after receiving both the first and second shares of the encoded password guesses T₁′ and T₂′, the user device 302 may generate a secret key, SK′. The user device 302 may process the first output (e.g., the first share of the encoded password guess T₁′) and the second output (the second share of the encoded password guess T₂′) to generate the secret key. For example, the user device 302 may use the combine function of the threshold oblivious pseudorandom function of step S208 of FIG. 2 to generate the secret key, SK′. Steps S200 through S208 of FIG. 2 are similar to steps S300 through S308 of FIG. 3. Thus, if the password guess, pwd′, is the same as the password, pwd, of FIG. 2 (e.g., the user operating the user device 302 successfully authenticates themselves), then the secret key, SK′, generated in step S308 is the same as the secret key, SK′, generated in step S208 (e.g., the user device 302 recovers the secret key, SK).

The user device 302 may then request the data from the entity computer which holds the encrypted data that it wants to obtain. For example (if the encrypted data was stored by the first entity computer 204), after generating the secret key, SK′, the user device 302 may request encrypted data from the first entity computer 204. The user device 302 may then use the secret key, SK′, to decrypt the encrypted data. In some embodiments, the entity computer storing the encrypted data may require the user of the user device 302 to authenticate herself using both the password and the biometric template stored in FIG. 2 before transmitting the encrypted data.

FIGS. 4A and 4B show a flow diagram for a user device 402 recovering a secret using a biometric measurement. A recovery attempt, similar to that of FIG. 3, may be made by the user device 402 to recover the secret stored in FIG. 2. In some embodiments, the recovery attempt using the biometric measurement may follow after the flow of FIG. 3.

In step S400, the user operating the user device 402 may measure a biometric measurement, BT′, using a biometric sensor of the user device 402. For example, the user may use a camera of the user device 402 to take a picture of the user's face (i.e., measure a facial scan). The biometric measurement, BT′, may be an example of a user identifier unique to a user. The user device 402 may then obscure the biometric measurement, BT′. For example, the user device 402 may then generate a first oblivious transfer receiver message, OT₁¹(BT′), using the biometric measurement, BT′, where the first oblivious transfer receiver message, OT₁¹(BT′), contains an obscured user identifier in the form of the obscured biometric measurement. The obscuring may be performed using any suitable method including public-private cryptography techniques. The user device 402 may then transmit the obscured user identifier (e.g., in the first oblivious transfer receiver message, OT₁¹(BT′)) to the first entity computer 204. For example, the user device 402 may then transmit the first oblivious transfer receive message, OT₁¹(BT′), to the first entity computer 204.

The user device 402 may use any suitable oblivious transfer protocol to generate the first oblivious transfer receiver message, OT₁¹(BT′). One example may be that of a two-message oblivious transfer protocol. Examples of oblivious transfer protocols can be found in “Smooth Projective Hashing and Two-Message Oblivious Transfer” by Halevi et al. in Journal of Cryptology volume 25, pages 158-193 (2012). Two-message oblivious transfer protocols allow the user device 402 to securely communicate with an external computer, such as the first entity computer 204. The receiver (e.g., the user device 402) may transmit an obscured input (e.g., the obscured biometric measurement, BT′) to a sender (e.g., the first entity computer 204). The sender (e.g., the first entity computer 204) may then generate an oblivious transfer sender message and transmit it to the receiver (e.g., the user device 402). Thus, an oblivious transfer protocol allows a receiver (e.g., the user device 402) to transmit an obscured input to a sender, and a sender to perform a computation (e.g., a comparison) using the obscured input, without ever learning the input. The receiver (e.g., the user device 402) may learn the result of the computation without learning any extra information.

In step S402, after receiving the first oblivious transfer receiver message, OT₁¹(BT′), the first entity computer 204 may generate a first random number, r₁. The first entity computer may then generate a MAC key using one of the three MAC key generators described above in the flow of FIG. 2. For example, the first entity computer 204 may generate a first MAC key, MAC_{U}, using the stored pseudorandom function key, MAC key generator U. A MAC hash function, known by each of the user device 402, first entity computer 204, and the second entity computer 206, may be used to authenticate messages between the user device 402 and the entity computers. For example, the first entity computer 204 may hash a message (e.g., a partial computation) with the MAC hash function using the first MAC key MAC_{U} and send the message to the user device 402 along with the original message. Another device that knows the MAC key generator U and the MAC hash function can then reconstruct the hashed message and verify that the reconstructed hashed message and received hashed messages are the same.

The first entity computer 204 may then generate a first output. The first output may include a garbled circuit, GC₁. Details of garbled circuits can be found in Heath and Kolesnikov, “Stacked Garbling: Garbled Circuit Proportional to Longest Execution Path,” Cryptology ePrint Archive: Report 2020/973, 2020. The first garbled circuit, GC₁, may be an encrypted circuit, which encrypts the inputs and outputs of a circuit according to assigned labels. The first entity computer 204 may first generate a circuit that can compare the biometric measurement, BT′, to the first biometric share, BT₁, obscure a comparison result, and can generate a MAC hashed message. The first entity computer 204 and may then encrypt the circuit thereby garbling it. As is known in the art, the first garbled circuit, GC₁, may be eventually be decrypted according using the labels (e.g., decryption keys). The labels may transform bits of an input into an encrypted representation according to the garbled circuit randomness, R (e.g., the garbled circuit randomness, R, may be used to generate an encryption key used to generate labels or may be used to directly generate random labels).

For example, a bit 0 may have a corresponding encryption or label, X₀^{j}, where j is the position of the bit in a string. A string of length three bits, such as 101, may thus have a label of X₁²X₀¹X₁⁰. The first garbled circuit, GC₁, may receive two inputs and perform a comparison between the two inputs (e.g., the two inputs may be the biometric measurement, BT′, and the first biometric share, BT₁) and output the comparison between the two inputs, and a first MAC hashed message MAC_{U}(x₁) using the first MAC key, MAC_{U}. For example, the first garbled circuit, GC₁, may take as input a biometric (e.g., the biometric measurement such as BT′) and a biometric template share (e.g., the first biometric template share BT₁) and compute a distance (e.g., by computing an inner product) between the input biometric and the biometric template share. The garbled circuit GC₁ may then mask the computed distance by the random number, r₁. Thus, the output of the first garbled circuit, GC₁, may be a first partial computation x₁=<BT′, BT₁>+r₁, and a first MAC hashed message MAC_{U}(x₁) (e.g., the first partial computation hashed using the MAC hash function with the first MAC key MAC_{U}).

The first entity computer 204 may then generate a first oblivious transfer sender message, OT₂¹. The first oblivious transfer sender message, OT₂¹, may reveal labels for the biometric measurement, BT, for the garbled circuit, GC₁, without revealing information on other labels used in the garbled circuit GC₁. The contents of the first oblivious transfer sender message, OT₂¹ may be considered part of the output from the first entity computer 204 in response to the message S402.

In step S406, the first entity computer 204 may transmit the first garbled circuit, GC₁, (e.g., an example of a first output), and the first oblivious transfer sender message, OT₂¹, and labels for the first biometric share BT₁, the first random number, r₁, and the MAC key generator, U, to the user device 402.

In step S408, after receiving the first oblivious transfer sender message OT₂¹, the labels for BT₁, r₁, and U, the user device 402 may complete the oblivious transfer protocol to learn labels for the biometric measurement, BT′. The user device 402 may then run the first garbled circuit, GC₁, using the labels for the biometric measurement BT′ and the labels for the first biometric share BT₁ as input. After running the first garbled circuit, GC₁, the user device 402 may learn the first partial computation x₁=<BT′, BT₁>+r₁ and the first MAC hashed message MAC_{U}(x₁). The user device 402 may verify the first MAC hashed message MAC_{U}(x₁) (e.g., by reconstructing it using the MAC key generator, U, the first partial computation, x₁, and the common MAC hash function) to verify both the integrity and the authenticity of the first garbled circuit, GC₁.

In step S410A, the user device 402 may transmit the first oblivious transfer receiver message OT₁¹(BT′) (e.g., the obscured user identifier) to the second entity computer 206. In an optional step S410B, the user device 402 may transmit the first oblivious transfer receiver message OT₁¹(BT′) to the first entity computer 204. In some embodiments, step S410B is not needed, and step S416 can be executed any time after step S402.

In step S412, after receiving the first oblivious transfer receiver message, OT₁¹(BT′), the second entity computer 206 may generate a second random number, r₂, using the second random value, R₂. The second entity computer 206 may then generate a second MAC key, MAC_{V}, using the MAC key generator, V, and the common MAC hash function and a second MAC hashed message MAC_{V}(x₂). The second entity computer 206 may then generate a second output. The second output may be a second garbled circuit, GC₂. The second garbled circuit, GC₂, may be generated and operate in a similar manner to the first garbled circuit, GC₁ (e.g., it may generate labels using the same garbled circuit randomness R), however, it may use the second MAC hashed message MAC_{V}(x₂). The output of the second garbled circuit, GC₂, may be a second partial computation x₂=<BT′, BT₂>+r₂ and the second MAC hashed message MAC_{V}(x₂). The second entity computer 206 may then generate a second oblivious transfer sender message, OT₂². The second oblivious transfer sender message, OT₂², may reveal labels for the second biometric share, BT₂.

In step S414, the second entity computer 206 may transmit the second garbled circuit, GC₂ (e.g., an example of the second output) and the second oblivious transfer sender message, OT₂², to the user device 402. In some embodiments, the second entity computer 206 may transmit labels for the random number, r₂, and the MAC key generator, V.

In step S416, after receiving the first oblivious transfer receiver message, OT₁¹(BT′), the first entity computer 204 may generate the second garbled circuit, GC₂, and the second oblivious transfer sender message, OT₂². Although the first entity computer 204 does not have the proper labels for the second biometric share, BT₂, the first entity computer 204 may still construct the correct form of the second garbled circuit GC₂ as it knows both the garbled circuit randomness, R, and the MAC key generator, V. The first entity computer 406 may then hash, using a hash function (e.g., the MAC hash function can be used) known to the user device 402, the second garbled circuit, GC₂, and the second oblivious transfer sender message, OT₂². The hashed second garbled circuit, GC₂, and the hashed second oblivious transfer sender message, OT₂², may then be transmitted to the user device 402. In some embodiments, step S416 may occur any time after step S402. In some embodiments, the first entity computer 204 may transmit labels for the second random number, r₂, and the MAC key generator, V.

In step S418, after receiving the hashed second garbled circuit, GC₂, and the hashed second oblivious transfer sender message, OT₂², from the first entity computer 204 and the non-hashed equivalents from the second entity computer 206, the user device 402 may verify the hashes. If the second garbled circuit, GC₂, and the second oblivious transfer sender message, OT₂², hash correctly and after the labels for the second random number, r₂, the MAC key generator, V, and the second biometric share BT₂ are known to the user device 402 (e.g., after completing the oblivious transfer protocol with the second entity computer 206 and receiving the labels for the second random number, r₂, and the MAC key generator, V, directly), the user device 402 may then evaluate the second garbled circuit GC₂ to learn the second partial computation x₂=<BT′, BT₂>+r₂ and the second MAC key, MAC_{V}. The user device 402 may verify the second MAC key, MAC_{V} (e.g., by reconstructing it using the MAC key generator, V, and the common MAC hash function) to verify both the integrity and the authenticity of the second garbled circuit, GC₂.

Steps S416 and S418 may be optional. These steps may be performed by the first entity computer 404, such as in the event that first entity computer 404 is a trusted authority, and needs to verify the trustworthiness of the second entity computer 406 or other entity computers.

In step S420, the user device 402 may generate a second oblivious transfer receiver message OT₁²(x₁, x₂, MAC_{U}(x₁), MAC_{V}(x₂)) using the first partial computation, x₁, the second partial computation, x₂, the first MAC hashed message MAC_{U}(x₁), and the second MAC hashed message MAC_{V}(x₂). The user device 402 may then transmit the second oblivious transfer receiver message OT₁²(x₁, x₂, MAC_{U}(x₁), MAC_{V}(x₂)) to the first entity computer 204.

In step S422, after receiving the second oblivious transfer receiver message OT₁²(x₁, x₂, MAC_{U}(x₁), MAC_{V}(x₁)), the first entity computer 204 may generate a random session identifier, sid, using the session identifier generator, N. The first entity computer 204 may then generate a third MAC key, MAC_{W}, using the MAC key generator, W, and use the third MAC key, MAC_{W}, to hash (e.g., using the public MAC hash function) the session identifier, sid to form a MAC verification message MAC_{w}(sid). The first entity computer 204 may then generate a third garbled circuit, GC₃, using the garbled circuit randomness R. The third garbled circuit, GC₃, may first verify the first and second MAC hashed messages, MAC_{U}(x₁) and MAC_{V}(x₂), and compare the biometric measurement BT′ to the stored biometric template BT of FIG. 2, via the first biometric share, BT₁, and the second biometric share, BT₂ by removing the random numbers r₁ and r₂ from the partial computations x₁ and x₂ (e.g., x₁+x₂−r₁−r₂). The third garbled circuit GC₃ can also encode the first secret key share SK₁ described above in FIG. 2. The first entity computer 204 may generate a third oblivious transfer sender message, OT₂³, which reveals labels for the partial computations x₁, and x₂, and the MAC keys MAC_{U} and MAC_{V}. The first entity computer 204 may then transmit labels for the first random number, r₁, the second random number, r₂, the session identifier, sid, the MAC key generator, W, and the first secret key share, SK₁.

In step S424, the first entity computer 204 may transmit the third garbled circuit, GC₃, and the third oblivious transfer sender message, OT₂³, to the user device 302.

In step S426, after receiving the third garbled circuit, GC₃, the third oblivious transfer sender message, OT₂³, and the set of labels, the user device 302 may complete the oblivious transfer protocol to learn the labels for partial computations x₁, and x₂, and the first and second MAC hashed messages MAC_{U}(x₁) and MAC_{V}(x₂). The user device 302 may then evaluate the third garbled circuit, GC₃, which verifies the first and second MAC hashed messages, MAC_{U}(x₁) and MAC_{V}(x₂), uses the partial computations x₁, and x₂ to determine if the biometric measurement (BT′) and the biometric template (BT, which is formed from BT¹ and BT²) to determine a match. If the biometric measurement and the biometric template match, then third garbled circuit, GC₃, outputs the first secret key share, SK₁. For example, the third garbled circuit, GC₃, may first verify the first and second MAC hashed messages, MAC_{U}(x₁) and MAC_{V}(x₂), by comparing them to a reconstructed form of the hashed messages (e.g., reconstruct by computing the first and second MAC keys MAC_{U} and MAC_{V}, and then hash the first and second partial computations x₁ and x₂ accordingly). Then, the third garbled circuit, GC₃, may compute a total distance between the biometric measurement, BT′, and the first and second biometric shares, BT₁ and BT₂, and if the total distance is lower than a threshold, the third garbled circuit, GC₃, may reveal the first secret key share SK₁. For example, the third garbled circuit, GC₃, may compute the total distance IP (inner product)=x₁+x₂−r₁−r₂=<BT, BT′>, as <BT₁, BT′>+<BT₂, BT>=<BT, BT′>. The total distance, IP, may then be compared to a threshold. If it is lower than the threshold, then the third garbled circuit, GC₃, may reveal the first secret key share, SK₁, and the MAC verification message, MAC_{W}(sid).

In step S428, after learning the MAC verification message, MAC_{W}(sid), the user device 402 may transmit the MAC verification message, MAC_{W}(sid), to the second entity computer 206.

In step S430, after receiving the MAC verification message, MAC_{W}(sid), the second entity computer 206 may verify the MAC verification message, MAC_{W}(sid). For example, the second entity computer 206 may generate the MAC verification message, MAC_{W}(sid), any time after step S414, and compare the generated MAC verification message, MAC_{W}(sid), to the received MAC verification message, MAC_{W}(sid).

In step S432, after comparing the generated and computed third MAC keys, and verifying the generated and computed MAC verification messages match, the second entity computer 206 may transmit the second secret key share, SK₂, to the user device 402. The user device 402 only learns the MAC verification message, MAC_{W}(sid) if the biometric measurement matches the biometric template. Thus, by simply verifying the MAC verification message, MAC_{W}(sid), the second entity computer 206 may ensure that the user device 402 should have access to the second secret key share SK₂, without the need to generate another garbled circuit similar to the third garbled circuit GC₃.

In step S434, after receiving the second secret key share, SK₂, the user device 402 may reconstruct the secret, SK, using the first and second secret key shares SK₁ and SK₂ according to the secret sharing technique that was used.

The user device 402 may then request the data from the entity computer which holds encrypted data. For example (if the encrypted data was stored by the first entity computer 204), after reconstructing the secret key, SK, the user device 402 may request encrypted data from the first entity computer 204. The user device 402 may then use the secret key, SK, to decrypt the encrypted data. In some embodiments, the entity computer storing the encrypted data may require the user device 402 to authenticate using both the biometric template and the password stored in FIG. 2 before transmitting the encrypted data.

FIG. 3 and FIGS. 4A and 4B demonstrate two flows for a user recovering a secret key. Embodiments of the invention have a number of advantages. In embodiments of the invention, the user may operate a user device which is not necessarily the user device that generated the secret. Both flows disclose a method for the user to generate the secret key at a later time, and from any user device other than the one that originally stored the secret key. In traditional systems, the secret is stored securely only on the user device which originally generated the secret. Thus, if the original user device is lost or malfunctions, the user may no longer have access to the secret. Embodiments shown by the figures provide the similar security benefits to storing the secret solely on the user device. The first entity computer and the second entity computer do not learn information about the user's biometric template, biometric measurement, password, password guess, or encrypted data. The entity computer that stores encrypted data cannot decrypt the data, as they never hold the complete secret. As the first and second entity computers can only communicate with the user device, the secret cannot be easily reconstructed by either of the entity computers. The biometrics and passwords are transmitted through secure protocols, the oblivious transfer protocol does not reveal information transmitted from the user device to the entity computer. Similarly, garbled circuits are encrypted circuits and when used in combination with the oblivious transfer protocols are able to perform computations with encrypted data.

FIG. 5 shows a block diagram of functions of a threshold oblivious pseudorandom function 500. The threshold oblivious pseudorandom function 500 may consist of at least a setup function 510, an encode function 520, an evaluate function 530, and a combine function 540. A summary of these functions follows, and one example construction of the threshold oblivious pseudorandom function 500 can be found in Shashank Agrawal and Peihan Miao and Payman Mohassel and Pratyay Mukherjee, “PASTA: PASsword-based Threshold Authentication,” Cryptology ePrint Archive, Report 2018/885, 2018, https://eprnt.iacr.org/2018/885.pdf.

The setup function 510 may take as input a security parameter, L, a number of shares, n, and a threshold t that is less than or equal to the number of shares n. The security parameter, L, may determine the length of the shares that will be generated, with a larger parameter leading to a longer and therefore more secure share. The threshold, t, may determine the number of shares required to reconstruct a secret. The output of the setup function 510 may be a set of n total key shares {kᵢ} and a set of public parameter, pp. The public parameters, pp, may be an implicit input to the subsequent functions. In embodiments of the invention, the number of shares n may be equal to 1, and the threshold t may also be equal to 1. For example, in step S200B, the first entity computer 204 may generate the pseudorandom function key share K₁.

The encode function 520 may take as input a value x and random value ρ. The output of the encode function 520 may be an encoding z of the value x. For example, in step S200A, the user device 202 may encode the password pwd to form the encoded password z.

The evaluate function 530 may take as input a key share kᵢ and the encoding z. The evaluate function 530 may generate a share of the encoding T₁. For example, the first entity computer 204 may take the pseudorandom function key share K₁ and the encoded password z as input and generate a first share of the encoded password T₁ in step S204A of FIG. 2.

The combine function 540 may take as input a value x, a set of shares of the encodings {i, Tᵢ}, and the random value ρ. The combine function 540 may output a value SK. For example, the user device 202 may input the password pwd, the first share of the encoded password K₁, the second share of the encoded password K₂, and the random value p to generate the secret key SK in step S208 of FIG. 2.

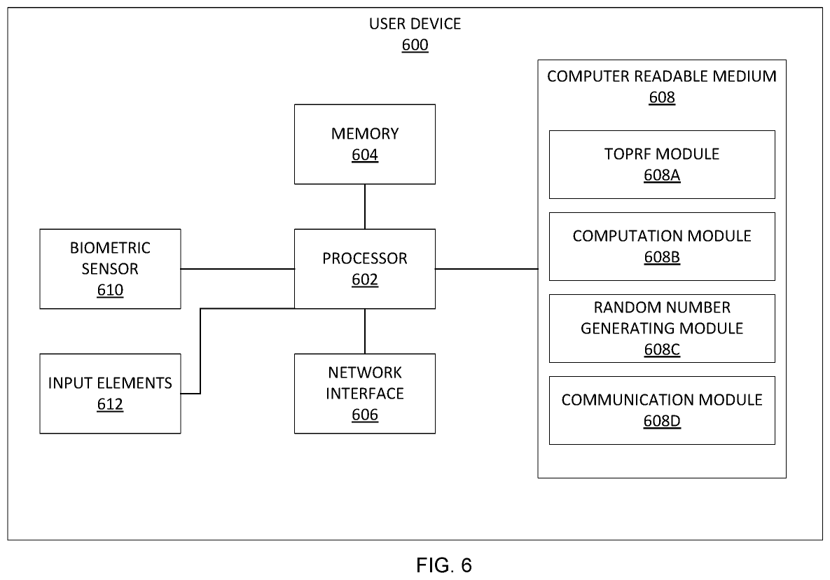

FIG. 6 shows a block diagram of an exemplary user device 600. The user device 600 may be operated by a user. The user device 600 may comprise a processor 602. The processor 602 may be coupled to a memory 604, a network interface 606, a computer readable medium 608, a biometric sensor 610, and input elements 612. The computer readable medium 608 may comprise any suitable number and types of software modules.

The memory 604 may be used to store data and code. The memory 604 may be coupled to the processor 602 internally or externally (e.g., via cloud based data storage), and may comprise any combination of volatile and/or non-volatile memory such as RAM, DRAM, ROM, flash, or any other suitable memory device. In some embodiments, the memory 604 may securely store the secret used to encrypt data.

The network interface 606 may include an interface that can allow the custodian computer 600 to communicate with external computers and/or devices. The network interface 606 may enable the custodian computer 600 to communicate data to and from another device such as an entity computer. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 606 may include Wi-Fi. Data transferred via the network interface 606 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 608 may comprise code, executable by the processor 602, for a method comprising: entering, in a user device, a user identifier unique to a user; obscuring, by the user device, the user identifier, with a function to form an obscured user identifier; transmitting, by the user device, the obscured user identifier to a first entity computer; transmitting, by the user device, the obscured user identifier to a second entity computer; wherein the first entity computer and the second entity computer do not communicate with each other in the key recovery process, and wherein the first entity computer generates a first output using the obscured user identifier and a first share, and the second entity computer generates a second output using the obscured user identifier and a second share; receiving, by the user device, the first output from the first entity computer; receiving, by the user device, the second output from the second entity computer; and generating a secret key after processing the first output and the second output

The computer readable medium 608 may comprise a number of software modules including, but not limited to, a threshold oblivious pseudorandom function module 608A, a computation module 608B, a random number generating module 608C, and a communication module 608D.

The threshold oblivious pseudorandom function module 608A may comprise code that causes the processor 602 to execute functions of a threshold oblivious pseudorandom function. For example, the threshold oblivious pseudorandom function module 608A may execute the encode function to encode a password in step S200A of FIG. 2, and the combine function to generate a secret key from shares of the encoded password in S208 of FIG. 2.

The computation module 608B may comprise code that causes the processor 602 to perform computations. For example, the computation module 608B may assist the threshold oblivious pseudorandom function module 608A in executing functions. The computation module 608B may additionally evaluate the garbled circuits of FIG. 4.

The random number generating module 608C may comprise code that causes the processor 602 to generate random numbers. For example, the random number generating module 608C may be used to generate the pseudorandom functions keys used for the threshold oblivious pseudorandom function, the MAC keys, the garbled circuits, etc.

The communication module 608D, in conjunction with the processor 602, can generate messages, forward messages, reformat messages, and/or otherwise communicate with other entities. For example, communication module 608D can be used to facilitate communications between the user device 600 and an entity computer. The communication module 608D may generate and verify communications between the user device 600 and entity computers. For example, the communication module 608D may receive a MAC key and a MAC key generator, then verify the MAC key generator correctly generates the MAC key. The communication module 608D may be used to complete oblivious transfer protocols.

The biometric sensor 610 and input elements 612 may be used to input a user identifier unique to the user (e.g., a biometric or a password). Examples of the biometric sensor 610 may be a camera, a microphone, a fingerprint sensor, etc. Input elements 612 may be a touchscreen, a keypad, a microphone, etc.

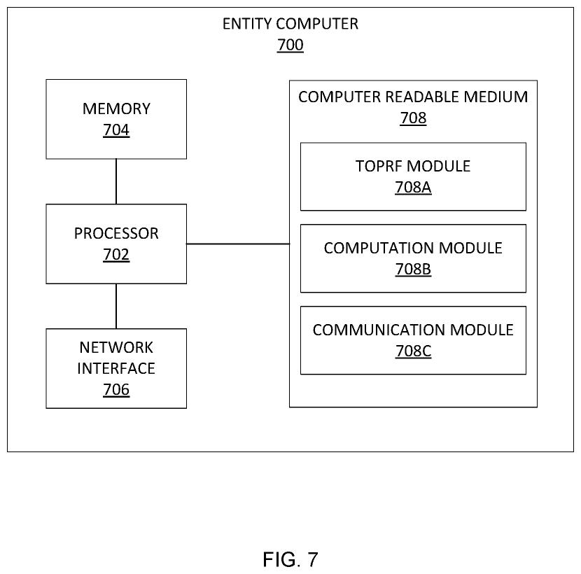

FIG. 7 shows a block diagram of an exemplary entity computer 700. The entity computer 700 may be operated by a trusted entity such as a government institution, a financial institution, etc. The entity computer 700 may comprise a processor 702. The processor 702 may be coupled to a memory 704, a network interface 706, and a computer readable medium 708. The computer readable medium 708 may comprise any suitable number and types of software modules.

The memory 704 may be used to store data and code. The memory 704 may be coupled to the processor 702 internally or externally (e.g., via cloud based data storage), and may comprise any combination of volatile and/or non-volatile memory such as RAM, DRAM, ROM, flash, or any other suitable memory device. In some embodiments, the memory 704 may securely store encrypted data. The memory 704 may be used to stored pseudorandom function keys (e.g., MAC key generators, garbled circuit randomness, etc.), threshold oblivious pseudorandom function key shares, encrypted data (e.g., data received from a user device), etc.

The network interface 706 may have the same or different features to the previously described network interface 606.

The computer readable medium 708 may comprise code, executable by the processor 702, for a method comprising: receiving, by an entity computer from a user device, an obscured user identifier; generating, by the entity computer, an output using the obscured user identifier and a share, wherein the share was previously generated using the obscured user identifier and stored by the entity computer; and transmitting, by the entity computer to the user device, the output

The computer readable medium 708 may comprise a number of software modules including, but not limited to, a TOPRF module 708A, a computation module 708B, and a communication module 708C.

The TOPRF module 708A may comprise code that causes the processor 702 to execute some or all of the functions of a threshold oblivious pseudorandom function. For example, the TOPRF module 708A may execute the setup function to generate a pseudorandom key share in S200B of FIG. 2, and the evaluation function to generate a share of an encoded password in step S204A.

The computation module 708B may comprise code that causes the processor 702 to perform computations. For example, the computation module 708B may assist the TOPRF module 708A in executing functions. The computation module 708B may generate a circuit and encrypt (e.g., garble) the circuit to generate the garbled circuits and labels of the garbled circuits of FIG. 4.

The communication module 708C may have the same or different features to the previously described network interface 608D.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a user device, a user identifier unique to a user;
obscuring, by the user device, the user identifier, with a function to form an obscured user identifier;
transmitting, by the user device, the obscured user identifier to a first entity computer;
transmitting, by the user device, the obscured user identifier to a second entity computer;
wherein the first entity computer and the second entity computer do not communicate with each other in the method, and wherein the first entity computer generates a first output after receiving the obscured user identifier, and the second entity computer generates a second output after receiving the obscured user identifier;
receiving, by the user device, the first output from the first entity computer;
receiving, by the user device, the second output from the second entity computer; and
generating a secret key after processing the first output and the second output.

2. The method of claim 1 further comprising:
encrypting, by the user device, data using the secret key to form encrypted data; and
transmitting, by the user device to one or both of the first entity computer or the second entity computer, the encrypted data.

3. The method of claim 2 further comprising:
transmitting, by the user device to one or both of the first entity computer or the second entity computer, a request for encrypted data, wherein the encrypted data was encrypted with the secret key;
receiving, by the user device from the one or both first entity computer or the second entity computer, the encrypted data; and
decrypting, by the user device, the encrypted data using the secret key.

4. The method of claim 1, wherein the first output comprises a first garbled circuit, the first garbled circuit configured to perform a comparison between the user identifier of the obscured user identifier and a user identifier share stored by the first entity computer.

5. The method of claim 4, wherein the user identifier is a biometric template and the user identifier share is a biometric template share of the biometric template.

6. The method of claim 1, wherein the user identifier is a password.

7. The method of claim 3, wherein the function is a threshold oblivious pseudorandom function.

8. The method of claim 1, wherein the user identifier is a password and the obscured user identifier is an encoded password, and the first output is first share of the encoded password, and the second output is a second share of the encoded password.

9. The method of claim 8, wherein the first share of the encoded password is formed by raising the encoded password to the power of a first key share, K₁ generated by the first entity computer, and wherein the second share of the encoded password is formed by raising the encoded password to the power of a second key share K₂ generated by the second entity computer.

10. The method of claim 1,
wherein obscuring the user identifier unique to the user with the function comprises obscuring a biometric measurement of the user with an oblivious transfer protocol;
the first output comprises a first garbled circuit; and
the second output comprises a second garbled circuit.

11. The method of claim 10, wherein the first garbled circuit is configured to compare a first biometric share to the biometric measurement, and also to produce a message authentication code hashed message.

12. The method of claim 1, wherein the user device is a mobile phone.

13. The method of claim 1, wherein the method is a set up process for a key recovery process.

14. The method of claim 1, wherein the method is a key recovery process.

15. A user device comprising:
a processor; and
a computer readable medium, the computer readable medium comprising code, executable by the processor, to perform a method including
receiving a user identifier unique to a user;
obscuring the user identifier, with a function to form an obscured user identifier;
transmitting the obscured user identifier to a first entity computer;
transmitting the obscured user identifier to a second entity computer;
wherein the first entity computer and the second entity computer do not communicate with each other in the method, and wherein the first entity computer generates a first output after receiving the obscured user identifier, and the second entity computer generates a second output after receiving the obscured user identifier;
receiving the first output from the first entity computer;
receiving the second output from the second entity computer; and
generating a secret key after processing the first output and the second output.

16. A method comprising:
receiving, by a first entity computer, an obscured user identifier from a user device, the obscured user identifier formed using a function and a user identifier unique to a user, and wherein the user device also transmits the obscured user identifier to a second entity computer, and wherein the first entity computer and the second entity computer do not communicate with each other in the method;
generating, by the first entity computer, a first output after receiving the obscured user identifier, and wherein the second entity computer generates a second output after receiving the obscured user identifier; and
transmitting, by the first entity computer, the first output to the user device, wherein the user device generates a secret key after processing the first output and the second output received from the second entity computer.

17. The method of claim 16, wherein the first entity computer is operated by a trusted entity.

18. The method of claim 16 wherein the first output comprises a first garbled circuit.

19. The method of claim 16, wherein the user identifier is a biometric or a password.

20. The method of claim 16, wherein the function is an oblivious transfer function.
